(19) United States
(12) Patent Application Publication
(10) Pub. No.: US 2006/0130605 A1
(43) Pub. Date: Jun. 22, 2006

(54) Bicycle front support

(76) Inventor: Chao-Hu Chen, Taichung Hsien (TW)

Correspondence Address: Chao-Hu Chen, 235 Chung - Ho, Box 8-24, Taipei, TW

(21) Appl. No.: 11/018,435

(22) Filed: Dec. 21, 2004

(51) Int. Cl. B62K 21/12

(52) U.S. Cl. 74/551.1

(57) ABSTRACT

A bicycle front support comprises a body having a front clamp at a front end thereof; a handle of a bicycle being engaged with the front clamp; a rear end of the body having a tubular rear ring; a tightening cover located upon the rear ring; the tightening cover having a tubular shape, and an upper side of the tightening cover having thread; and a tightening ring having a ring shape and being threaded to the thread of the tightening cover. The bicycle front support makes the structure of a bicycle become stronger and have a beautiful outlook.

### FIELD OF THE INVENTION

The present invention relates to bicycle components, and in particular to a bicycle front support which makes the structure of a bicycle become stronger and has a beautiful outlook.

### BACKGROUND OF THE INVENTION

A bicycle front support is used to connect a handle of a bicycle to a bi-forked tube. In one prior art, the bicycle front support has a transversal tube and two rings at two ends of the transversal tube. One ring serves to lock the bi-forked tube and another ring serves to lock the handle. Each ring has a slit for locking screw means. When engaging a bi-forked tube of a bicycle, screws are used to lock the ring. However the slits at sides of the rings make the manufacturing process be complicated. Thereby the screws protruded out of the rings make the outlook unbeautiful. Thereby the seating cushion is installed behind the bi-forked tube, and the protruded screws will hurt the rider. Thereby only using screw means to lock the bi-forked tube cannot provide a sufficient support to the bi-forked tube.

### SUMMARY OF THE INVENTION

Accordingly, the primary object of the present invention is to provide a bicycle front support which makes the structure of a bicycle become stronger and has a beautiful outlook.

To achieve above objects, the present invention provides a bicycle front support which comprises a body having a front clamp at a front end thereof; a handle of a bicycle being engaged with the front clamp; a rear end of the body having a tubular rear ring; a tightening cover located upon the rear ring; the tightening cover having a tubular shape; and an upper side of the tightening cover having thread; and a tightening ring having a ring shape and being threaded to the thread of the tightening cover.

The various objects and advantages of the present invention will be more readily understood from the following detailed description when read in conjunction with the appended drawing.

### BRIEF DESCRIPTION OF THE DRAWINGS

FIG. 1 is a structural exploded view of the bicycle front support of the present invention.

FIGS. 2 and 3 is an assembled view of the bicycle front support of the present invention.

FIG. 4 is a schematic view about the assembly of the bicycle front support of the present invention.

FIG. 5 is a cross sectional view of the second embodiment of the present invention.

FIG. 6 is a perspective view about the second embodiment of the present invention.

FIG. 7 is an exploded schematic view about the third embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

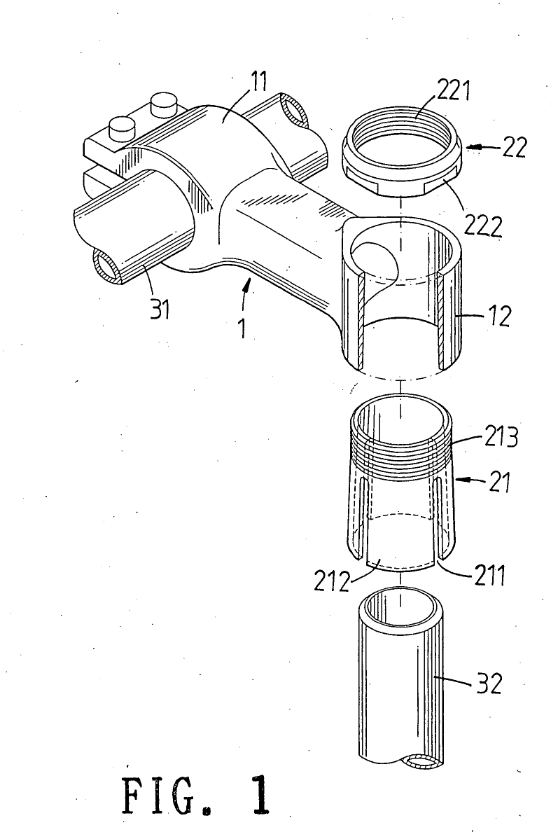

With reference to FIGS. 1 to 3, the bicycle front support of the present invention is illustrated. The present invention has the following elements.

A body 1 has a front clamp 11 at a front end thereof. A handle 31 of a bicycle is engaged with the front clamp 11. A rear end of the body 1 has a tubular rear ring 12. An axial direction of the rear ring 12 is vertical to that of the front clamp 11.

A tightening cover 21 is located upon the rear ring 12. The tightening cover 21 has a frustrated conical shape with a small opening at an upper end and a larger opening at a lower end. A lower side of the tightening cover 21 has a plurality of slits 211 so as to divide the tightening cover 21 into a plurality of resisting portions 212 (in this embodiment, four slits 211 and four resisting portions 212 are illustrated) so that the resisting portions 212 are compressible and expandable. An upper side of the tightening cover 21 has thread 213.

A tightening ring 22 has a ring shape and is threaded to the thread 213 of the tightening cover 21. An outer diameter of the tightening ring 22 is greater than that of the rear ring 12. An inner side of the tightening ring 22 has thread 221 corresponding to the tightening cover 21 so that the tightening ring 22 is engaged with the thread 213 of the tightening cover 21. An outer side of the tightening ring 22 has a plurality of notches 222 for tightly engaging the tightening ring 22.

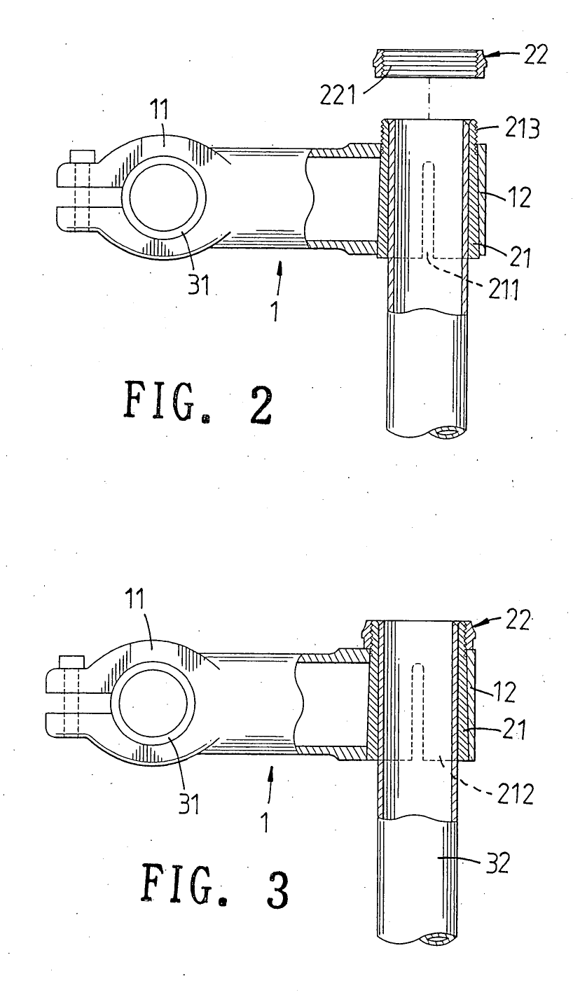

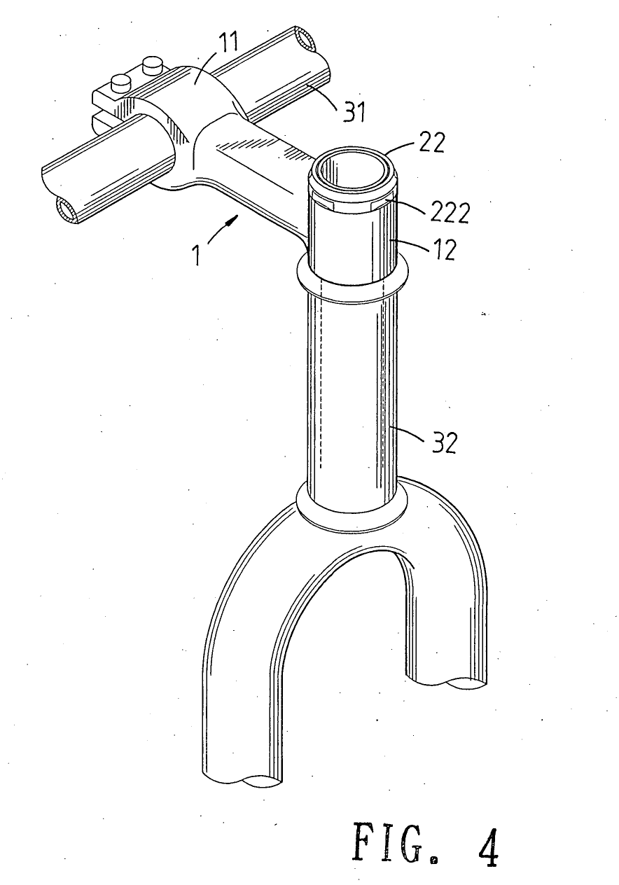

In assembly, referring to FIGS. 2 to 4, a bi-forked tube 32 is inserted into the tightening cover 21 from a lower end thereof so that the tightening cover 21 is installed at one end of the tightening cover 21. The tightening cover 21 inserts into a lower end of the rear ring 12 so that the thread 213 of the tightening cover 21 protrudes out of the rear ring 12. Then, the tightening ring 22 is engaged to the thread 213 of the tightening cover 21. Then the tightening ring 22 is screwed. The notches 222 at the outer side of the tightening ring 22 will increase the friction force in screwing so that the tightening ring 22 can be tightened easily. When the tightening ring 22 is screwed into the tightening cover 21, the tightening cover 21 will pull upwards gradually so that the resisting portions 212 at the lower side of the tightening cover 21 is plugged into the rear ring 12. Since the resisting portions 212 are elastic, when the resisting portions 212 is plugged into the rear ring 12. Thereby the tightening cover 21 can be tightly engaged into the bi-forked tube 32 by using the resisting portions 212. The assembly view is illustrated in the FIG. 4. In the present invention, the rear ring 12 serves to fix the bi-forked tube 32 by using the tightening ring 22 and the tightening cover 21. Thereby a beautiful outlook is presented. Thereby the tightening cover 21 clamps the bi-forked tube 32 by using the resisting portions 212. Thus the strength of the structure is improved.

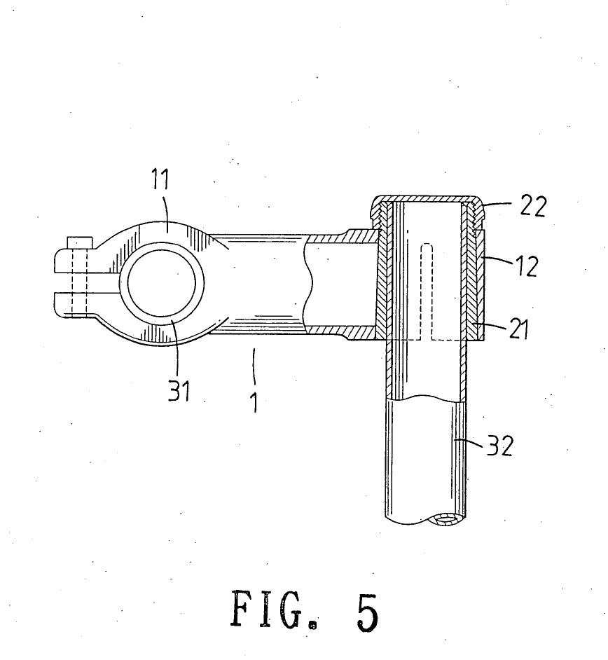

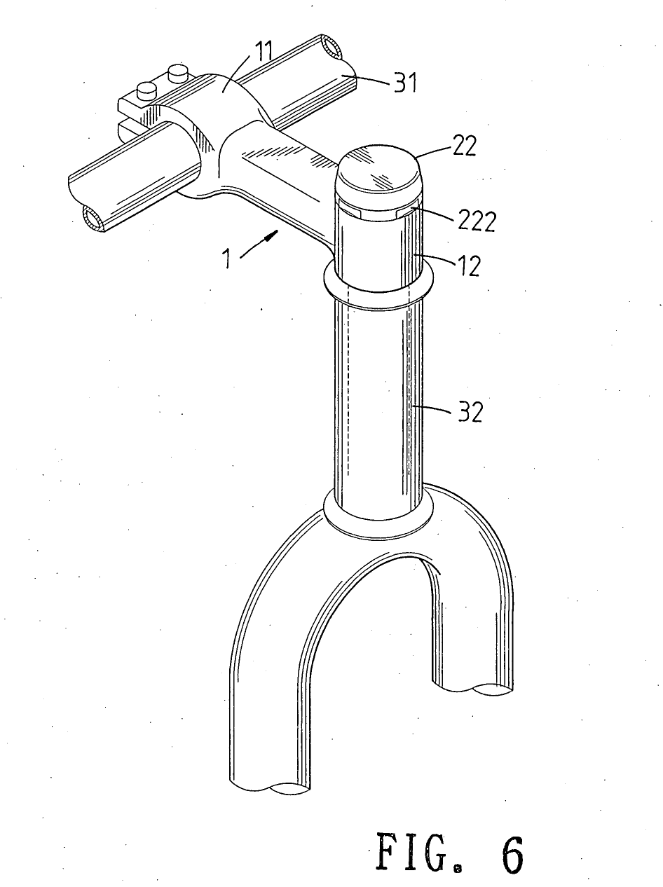

Referring to FIGS. 5 and 6; the second embodiment of the present invention is illustrated. Those same as the first embodiment will not be described herein. The difference of the two will be described in the following. In this embodiment, the tightening ring 22 is a round cap. When the tightening ring 22 is engaged to the thread 213 of the tightening cover 21, the tightening ring 22 will seal the upper side of the rear ring 12. Therefore, a beautiful outlook is presented.

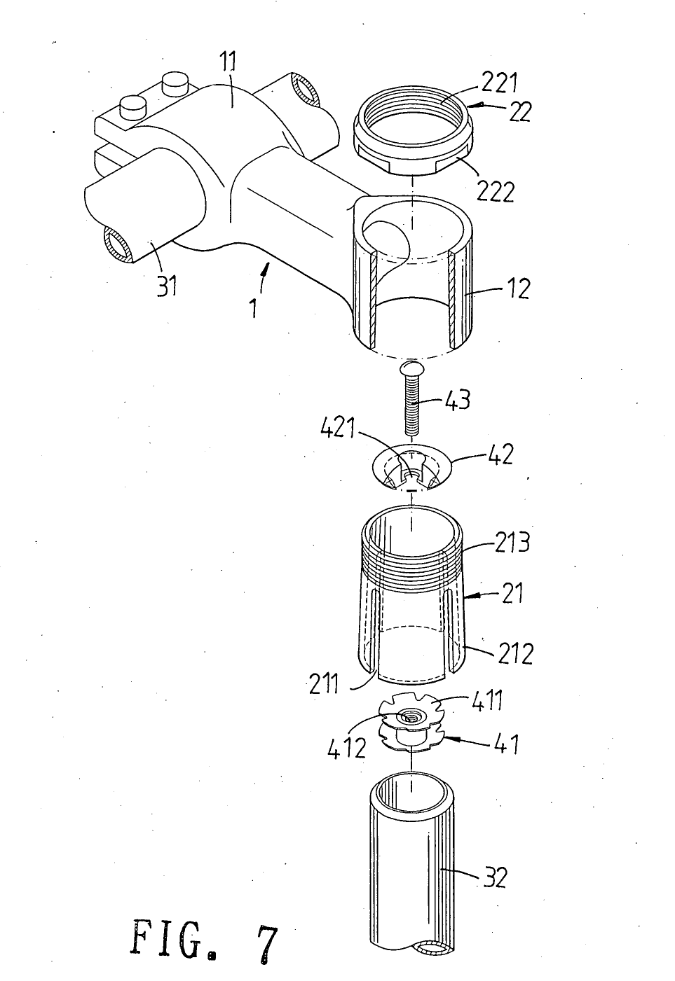

With reference to FIG. 7, the third embodiment of the present invention is illustrated. In the present invention, a locking element is locked between the tightening cover 21 and the bi-forked tube 32 so as to enhance the combining force. In this embodiment, the locking element includes a toggle 41, a ring cover 42 and a screw 43. The toggle 41 is installed with a plurality of cambered resisting sheets 411. The toggle 41 can be engaged into the bi-forked tube 32 by the cambered resisting sheets 411 so that the toggle 41 cannot be taken out. A center of the toggle 41 has a screwing hole 412. The ring cover 42 has a disk like shape. An outer diameter of the ring cover 42 is slightly larger than an inner diameter of the upper end of the tightening cover 21 so that the ring cover 42 will not fall into the tightening cover 21 without interfering the combination of the tightening cover 21 and the rear ring 12 or the tightening ring 22. A center of the ring cover 42 has a through hole 421 for screwing a screw 43 and the screw 43 is locked to the screwing hole 412 of the toggle 41. Thereby the ring cover 42, the tightening cover 21, the toggle 41 and the bi-forked tube 32 are combined tightly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle front support comprising:
a body having a front clamp at a front end thereof; a handle of a bicycle being engaged with the front clamp; a rear end of the body having a tubular rear ring;
a tightening cover located upon the rear ring; the tightening cover having a tubular shape; and an upper side of the tightening cover having thread; and
a tightening ring having a ring shape and being threaded to the thread of the tightening cover.

2. The bicycle front support as claimed in claim 1, wherein an outer side of the tightening cover has a frustrated conical shape; and the tightening cover is engaged to the rear ring.

3. The bicycle front support as claimed in claim 1, wherein an outer side of the tightening cover has at least one notch.

4. The bicycle front support as claimed in claim 1, wherein a lower end of the tightening cover has at least two resisting portions which are elastic so as to enhance the strength of the combination of the tightening cover and bi-forked tube.

5. The bicycle front support as claimed in claim 1, wherein the tightening ring is a round cover for sealing an upper end of the rear ring.

6. The bicycle front support as claimed in claim 1, wherein a locking element is locked between the tightening cover and the bi-forked tube.

7. The bicycle front support as claimed in claim 6, wherein the locking element includes a toggle, a ring cover and a screw.

8. The bicycle front support as claimed in claim 7, wherein the toggle is installed with a plurality of cambered resisting sheets; the toggle is engaged into the bi-forked tube by the cambered resisting sheets so that the toggle can not be taken out; a center of the toggle has a screwing hole; the ring cover has a disk like shape; an outer diameter of the ring cover is slightly larger than an inner diameter of the upper end of the tightening cover; a center of the ring cover has a through hole for screwing a screw and the screw is locked to the screwing hole of the toggle.

9. The bicycle front support as claimed in claim 1, wherein an outer diameter of the tightening ring is greater than that of the rear ring; an inner side of the tightening ring has thread corresponding to the tightening cover so that the tightening ring is engaged with the thread of the tightening cover; an outer side of the tightening ring has a plurality of notches for tightly engaging the tightening ring.

10. The bicycle front support as claimed in claim 1, wherein a lower side of the tightening cover has a plurality of slits so as to divide the tightening cover into a plurality of resisting portions so that the resisting portions are elastic.
